(19) United States
(12) Patent Application Publication
(10) Pub. No.: US 2005/0200275 A1
(43) Pub. Date: Sep. 15, 2005

(54) Dual-direction organic light-emitting diode display

(76) Inventors: Yaw-Ming Tsai, Taichung Hsien (TW); Shih-Chang Chang, Hsinchu (TW)

Correspondence Address: Min, Hsieh & Hack, LLP;c/o PortfolioIP, P.O. Box 52050, Minneapolis, MN, 55402, US

(21) Appl. No.: 11/013,731

(22) Filed: Dec. 16, 2004

(30) Foreign Application Priority Data
Mar. 11, 2004 (TW) 93106444

(51) Int. Cl. H01J 1/62; H01J 63/04

(52) U.S. Cl. 313/504

(57) ABSTRACT

A dual-direction organic light-emitting diode (OLED) display structure. The dual-direction OLED display structure comprises an active matrix array substrate with a first color filter integrated thereon. A monochromatic organic light-emitting device is disposed on the active matrix array substrate. A transparent substrate is disposed on the monochromatic organic light emitting diode display. A second color filter is interposed between the transparent substrate and the monochromatic organic light-emitting device.

### DESCRIPTION OF THE INVENTION

1. Field of the Invention

The invention relates to an organic light-emitting diode (OLED) display, and in particular, a dual-direction organic light-emitting diode display comprising a first region displaying in a first direction and a second region displaying in an essentially opposite second direction.

2. Background of the Invention

An organic light-emitting diode (OLED) is an LED that uses an organic layer as the active layer. In recent years, OLEDs have been gradually applied in flat panel displays and offer many advantages, such as low voltage operation, high brightness, light weight and slim profile, full viewing angle, and high effective contrast ratio.

One of the main characteristics of a dual-direction display is the ability to display data on front and rear surfaces of the dual-direction display applied in clamshell type mobile phones, personal digital assistants (PDAs), portable computers, and the like. A conventional clamshell type mobile phone utilizes two individual LCDs whose rear surfaces are in contact with each other to achieve a dual-direction display.

However, since the conventional dual-direction display uses two individual displays, two sets of electrical equipment for driving the LCDs are required. Accordingly, the display increases in size and weight and the fabrication cost also increases.

FIG. 1 shows a conventional dual-direction display arrangement structure with two LCD displays opposite to each other, a first display D1 towards the outside of the device and a second display D2 towards the inside of the device. Referring to FIG. 1, display D1 is topmost with the viewing direction V1 from top downwards, and display D2 is lower with the viewing direction V2 from bottom upwards. The structure of the displays has been simplified. Display D1 includes a first LCD 10 and a backlight module 20, and display D2 includes a second LCD 30 and a backlight module 40. Both displays however have the same thickness and the thickness of the device increases when folded against each other.

FIG. 2 shows a cross-section of a conventional dual-direction OLED display structure. Three primary colors (red, green and blue) of the organic light emitting device 200 are disposed on a substrate with a TFT array. The organic light emitting device 200 includes a transparent electrode that operates the dual-direction emitting display. A protective layer 300 is disposed on the organic light emitting device 200.

One of the drawbacks to the use of OLEDs in displays is the generation of the colors necessary to achieve a full color display. Red, green and blue OLEDs can be fabricated but they require different organic materials, thus, each color must be fabricated separately. Furthermore, long-term OLED display reliability also remains a concern. One issue, for instance, is differential aging of the display, which affects color quality. The power efficiency of pixels in a display will drift over time due to operational degradation. The individual pixels in a display exhibit the effects of aging, in accordance with their use. The brightness non-uniformity due to differential aging reduces the useful display lifetime.

### SUMMARY OF THE INVENTION

In accordance with the invention, the present invention relates to a dual-direction OLED display structure using white peak luminescence OLED to prevent color aging. The combination of a white electroluminescence material and a color filter does not require precise alignment as is required with pixelized OLED displays. White electroluminescent and color filter type displays, various embodiments of which are disclosed herein, are suitable for large-sized, high-definition displays.

According to various embodiments described herein there is a dual-direction OLED display structure for displaying data on front and rear surfaces thereof.

According to various embodiments described herein there is a dual-direction OLED display structure with a monochromatic OLED.

According to various embodiments described herein there is a dual-direction OLED display structure using white peak luminescence OLED to prevent color aging.

According to various embodiments described herein there is a dual-direction OLED display structure comprising an active matrix array substrate with a first color filter integrated thereon, a monochromatic organic light-emitting device disposed on the active matrix array substrate, a transparent substrate disposed on the monochromatic organic light emitting device, and a second color filter interposed between the monochromatic organic light emitting device and the transparent substrate.

According to various embodiments, the monochromatic organic light emitting device includes a white peak luminescence OLED.

According to various embodiments the monochromatic organic light emitting device includes an anode electrode disposed on the active matrix array substrate, an organic electroluminescence stratum disposed on the anode electrode, wherein the organic electroluminescence stratum includes a hole injection layer (HIL), a hole transport layer (HTL), a light emitting layer (EL), an electron transport layer (ETL), and an electron injection layer (EIL); and a cathode electrode disposed on the organic electroluminescence stratum.

It is understood that the anode electrode can include a transparent oxide, such as, for example an indium tin oxide (ITO) layer. The cathode can include low work function materials, such as, Ca, Mg, Al or their alloys either alone or as a layered stratum. Moreover, in various embodiments, the cathode can comprise Ca, Mg, Al or their alloys, and indium tin oxide (ITO) either alone or as a layered stratum.

According to various embodiments described herein there is a dual-direction OLED display structure comprising a dual-direction organic light-emitting diode (OLED) display structure comprising an active matrix array substrate with a first color filter integrated thereon, a monochromatic organic light-emitting device disposed on the active matrix array substrate, a second color filter disposed on the monochromatic organic light emitting device, and a protective layer disposed on the second color filter.

According to various embodiments described herein there is a dual-direction OLED display structure, for use in, for example, a clamshell type mobile phone having first and second display regions. According to various embodiments, the dual-direction OLED display structure comprises an active matrix array substrate with a first color filter integrated thereon, an anode electrode formed on the active matrix array substrate, an organic electroluminescence stratum formed on the anode electrode. According to various embodiments the organic electroluminescence stratum can include a hole injection layer (HIL), a hole transport layer (HTL), a light emitting layer (EL), an electron transport layer (ETL), and an electron injection layer (EIL), a cathode electrode formed on the organic electroluminescence stratum, a second color filter formed on the organic electroluminescence stratum, and a transparent substrate disposed on the second color filter opposing the active matrix array substrate.

According to various embodiments described herein there is a first display region is smaller than the second display region.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a cross-section of a conventional dual-direction display arrangement structure;

FIG. 2 is a cross-section of a conventional dual-direction display OLED structure;

FIG. 3 depicts a cross-section of a dual-direction OLED display structure as disclosed in an exemplary embodiment of the present invention; and

FIG. 4 depicts a cross-section of a dual-direction OLED display structure as disclosed in another embodiment of the present invention.

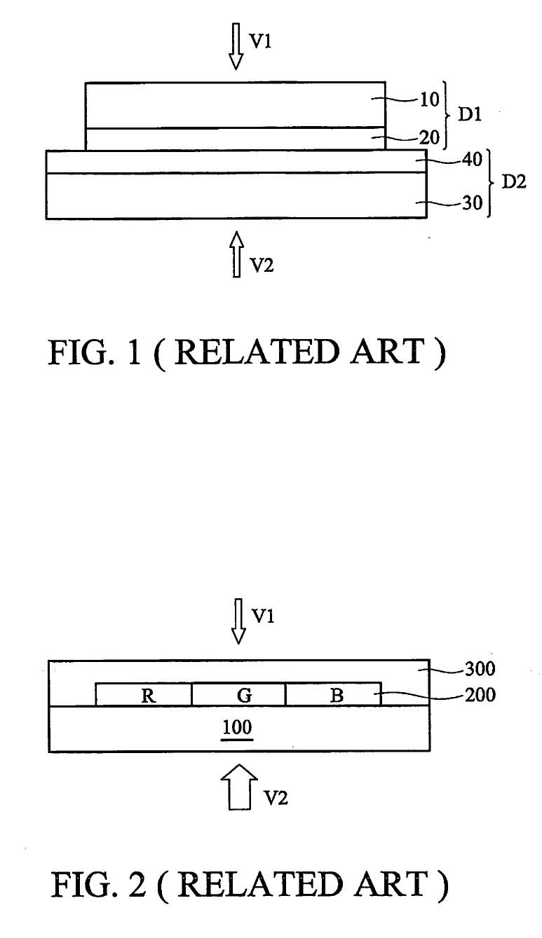

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

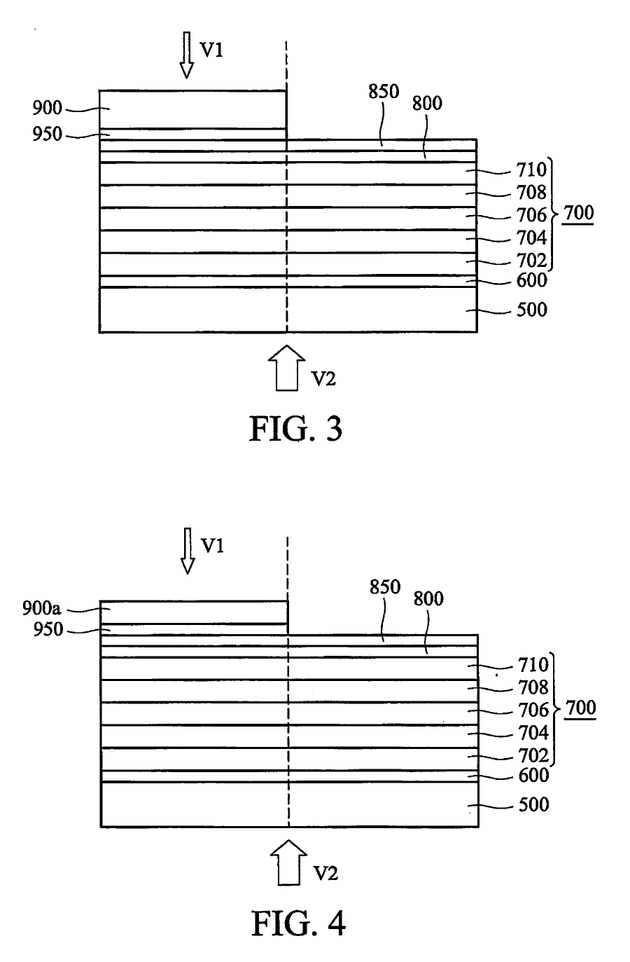

The present invention provides a dual-direction OLED display structure. FIG. 3 is a cross-section of a dual-direction OLED display structure according to various embodiments of the present invention.

Referring FIG. 3, there is an active matrix array substrate 500. According to various embodiments the active matrix array substrate 500 can include a first color filter (not shown) integrated thereon (hereinafter simply referred to as color filter on array (COA) substrate). The COA substrate 500 can be a transparent substrate, such as a glass or a quartz substrate. The glass plates can also be replaced with plastics, if a lighter and more robust construction is desired. The COA substrate 500 can comprise a pixel driving element array (e.g. a low temperature polysilicon thin film transistor (LTPS-TFT) array, not shown) which is suitable for a current driven device such as an OLED.

Subsequently, an anode electrode 600 of an OLED is formed on the COA substrate 500. Suitable material for the anode electrode 600 of the OLED can be one that injects electric holes into the organic semiconductor. Examples of suitable materials include, for example, indium tin oxide (ITO) or indium zinc oxide (IZO).

An organic electroluminescence stratum 700 is formed on the anode electrode 600. The organic electroluminescence stratum 700 can comprise an organic semiconducting material, such as small molecule material (oligomer), polymer, or organometallic complex. According to various embodiments organic electroluminescence stratum 700 can comprise a hole injection layer (HIL) 710, a hole transport layer (HTL) 708, a light emitting layer (EL) 706, an electron transport layer (ETL) 704, and an electron injection layer (EIL) 702.

According to various embodiments the OLED can include a monochromatic OLED, such as a white luminescence OLED (white OLED, also called a white peak OLED). According to certain embodiments, white OLEDs can emit a broad spectrum of wavelengths of light. As such, the emission can be considered full spectrum or white light. White OLEDs can comprise a material, such as an organic semiconductor or other material, having a set of atoms or molecules of various energy gaps that emit varoius wavelengths of light, or white light. In other embodiments, the OLED material can emit various colors and when used in conjunction with a phosphor, produce white light.

A cathode electrode 800 is formed on the organic electroluminescence stratum 700. According to various embodiments the cathode can comprise a material capable of injecting electrons into an organic semiconductor. Exemplary injection materials can include a low work function material. For example, injection materials can include Ca, Mg, Al or their alloys either alone or in combination, such as in a layered stratum. Moreover, injection materials can include Mg, Mg alloy, Mg—Al alloy and indium tin oxide (ITO) either alone or in combination, such as in a layered stratum. A passivation layer 850 is formed on the cathode electrode 800 to protect the organic electroluminescence element.

A transparent substrate 900 is disposed on the cathode electrode 800 opposite to the COA substrate 500. A second color filter 950 can also be interposed between the transparent substrate 900 and the cathode electrode 800. According to various embodiments, various colors, and in some cases all colors, such as the visible colors, can be produced with pixels provided with red, green and blue filters. According to various embodiments, the second color filter 950 can be a single layer in which case the desired color is obtained when light is emitted upwards. The desired color can also be obtained when light is emitted downwards through the COA substrate 500.

According to certain embodiments, at least one predetermined color filter can filter out predetermined wavelengths of light emitted from the white OLEDs. The color filters can permit the emission from the white OLEDs to display a desired color, or set of colors, in a specified location. Further, use of the white OLEDs in combination with color filters simplifies the alignment of display elements. For example, the filters are easily positioned proximate to the white OLEDs. Moreover, the white OLEDs are easily positioned in the display.

FIG. 4 depicts a cross-section of a dual-direction OLED display structure as disclosed in another embodiment of the present invention. A cathode electrode 800 is formed on the organic electroluminescence stratum 700. According to various embodiments a cathode of an OLED can comprise a material capable of injecting electrons into an organic semiconductor. Exemplary injection materials can include low work function materials. For example, injection materials can include Ca, Mg, Al or their alloys either alone or in combination, such as in a layered stratum. Moreover, injection materials can include Mg, Mg alloy, Mg—Al alloy, and indium tin oxide (ITO),either alone or in combination, such as in a layered stratum. A passivation layer 850 is formed on the cathode electrode 800 to protect organic electroluminescence element.

A second color filter 950 can be disposed on the passivation layer 850 opposite to the COA array. A protective layer 900a is formed on the second color filter 950. The protective layer can be a polymer, such as an epoxy resin or acrylic resin.

The dual-direction OLED display can comprise a first display region viewing from direction V1 and a second display region viewing from direction V2. According to various embodiments, the first display region V1 can be smaller than the second display region V2. In various embodiments of the dual-direction OLED display, each display unit can consist of an active device on the COA substrate. Moreover, in various embodiments each display unit can consists only one active device on the COA substrate. In this case only one driving circuit or driving element is needed to display or control both the first display region V1 and the second display region V2. Further, the dual-direction OLED display can further comprise a switching device (not shown). Hence, the first display region V1 can serve as a main display region and the second display V2 region can serve as an auxiliary display region.

According to various embodiments a dual-direction OLED display structure comprising a white peak luminescence OLED to prevent or reduce color aging is provided. The combination of a white electroluminescence material and a color filter does not require precise alignment as rigorous as pixelized OLED displays. The white electroluminescent and color filter type display is suitable for large-sized, high-definition displays.

While the invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A dual-direction organic light-emitting diode (OLED) display structure comprising:
an active matrix array substrate with a first color filter integrated thereon;
a monochromatic organic light-emitting device disposed on the active matrix array substrate;
a transparent substrate disposed on the monochromatic organic light emitting device; and
a second color filter interposed between the monochromatic organic light emitting device and the transparent substrate.

2. The display as claimed in claim 1, wherein the monochromatic organic light emitting device is a white peak luminescence OLED.

3. The display as claimed in claim 1, wherein the monochromatic organic light emitting device comprises:
an anode electrode disposed on the active matrix array substrate;
an organic electroluminescence stratum disposed on the anode electrode; wherein the organic electroluminescence stratum comprises a hole injection layer (HIL), a hole transport layer (HTL), a light emitting layer (EL), an electron transport layer (ETL), and an electron injection layer (EIL);
a cathode electrode disposed on the organic electroluminescence stratum.

4. The display as claimed in claim 3, wherein the anode electrode comprises a transparent layer.

5. The display as claimed in claim 3, wherein the anode electrode comprises an indium tin oxide (ITO) layer.

6. The display as claimed in claim 3, wherein the cathode comprises a low work function material.

7. The display as claimed in claim 3, wherein the cathode comprises at least one of Mg, Mg alloy, Mg—Al alloy, and indium tin oxide (ITO).

8. A dual-direction organic light-emitting diode (OLED) display structure comprising:
an active matrix array substrate with a first color filter integrated thereon;
a monochromatic organic light-emitting device disposed on the active matrix array substrate;
a second color filter disposed on the monochromatic organic light emitting device; and
a protective layer disposed on the second color filter.

9. The display as claimed in claim 8, wherein the monochromatic organic light emitting device is white peak luminescence OLED.

10. The display as claimed in claim 8, wherein the monochromatic organic light emitting device comprises:
an anode electrode disposed on the active matrix array substrate;
an organic electroluminescence stratum disposed on the anode electrode; wherein the organic electroluminescence stratum includes a hole injection layer (HIL), a hole transport layer (HTL), a light emitting layer (EL), an electron transport layer (ETL), and an electron injection layer (EIL);
a cathode electrode disposed on the organic electroluminescence stratum.

11. The display as claimed in claim 10, wherein the anode electrode comprises a transparent layer.

12. The display as claimed in claim 10, wherein the anode electrode comprises an indium tin oxide (ITO) layer.

13. The display as claimed in claim 10, wherein the cathode comprises a low work function material.

14. The display as claimed in claim 10, wherein the cathode comprises at least one of Mg, Mg alloy, Mg—Al alloy, and indium tin oxide (ITO).

15. The dual-direction organic light-emitting diode (OLED) display structure, for a clamshell type mobile phone having first and second display regions, comprising:
an active matrix array substrate with a first color filter integrated thereon;
an anode electrode formed on the active matrix array substrate;
an organic electroluminescence stratum formed on the anode electrode, wherein the organic electroluminescence stratum includes a hole injection layer (HIL), a hole transport layer (HTL), a light emitting layer (EL), an electron transport layer (ETL), and an electron injection layer (EIL);
a cathode electrode formed on the organic electroluminescence stratum;
a second color filter formed on the organic electroluminescence stratum; and
a transparent substrate disposed on the second color filter opposing the active matrix array substrate.

16. The display as claimed in claim 15, wherein the first display region is smaller than the second display region.

17. The display as claimed in claim 15, wherein the anode electrode comprises a transparent layer.

18. The display as claimed in claim 15, wherein the anode electrode is an indium tin oxide (ITO) layer.

19. The display as claimed in claim 15, wherein the cathode comprises at least one of Mg, Mg alloy, Mg—Al alloy, and indium tin oxide (ITO).

20. The display as claimed in claim 15 further comprising one driving circuit to control the first display region and the second display region.
